(19) United States
(12) Patent Application Publication
(10) Pub. No.: US 2012/0094077 A1
(43) Pub. Date: Apr. 19, 2012

(54) AIRCRAFT COMPONENT COMPRISING PANELS STIFFENED WITH STRINGERS HAVING TWO TYPES OF LOCAL FLARINGS

(76) Inventors: José Orencio Granado Macarrilla, Madrid (ES); Vicente Martinez Valdegrama, Madrid (ES); Alberto Lozano Sevilla, Madrid (ES)

(21) Appl. No.: 13/113,489

(22) Filed: May 23, 2011

(30) Foreign Application Priority Data
Jun. 30, 2010 (ES) ES 201031012

(51) Int. Cl. B32B 3/00

(52) U.S. Cl. 428/156

(57) ABSTRACT

Aircraft component which comprises at least one panel (11) of composite material, formed by a skin (13) and a plurality of stiffening stringers (15) which are configured with a core (17) and a base (19) of width (A), said stiffening stringers (15) comprising first local flarings (21) of their bases (19) intended to provide areas for joining with other parts located in flat zones of the skin (13) and second local flarings (23) of their bases (19) which are intended to provide areas for joining with other parts located in zones of the skin (13) which include change-in-thickness ramps (33), being configured in the form of two end sections (41, 45) located above flat zones of the skin (13) and a central section (43) located above one of said ramps (33) of the skin (13), one of said end sections (41, 45) acting as an area for joining with other parts.

### FIELD OF THE INVENTION

The present invention relates to an aircraft component comprising panels stiffened with stringers and, more particularly, to a configuration of the local flarings of the stringers which allows them to be located in ramp zones of the skin.

### PRIOR ART

At present widespread use is made of composite materials, consisting of an organic matrix and continuous fibres based mainly on epoxy resins and carbon fibres, in a wide range of structural components, in particular for the aeronautical industry.

In many aircraft components which are manufactured using composite materials, panels stiffened with stringers, the profiles of which have zones intersecting with other structural parts of the component, are used.

Said stringers are generally configured with a core and a base (typically T-shaped), the base including local flarings in those zones which are joined to other parts, in particular by means of rivets.

In the case, for example, of an aircraft wing in which the stiffened panels are formed by means of stringers which are co-bonded to the skin, these local flarings are used to join to the panel other parts such as ribs or supports for devices. In particular, in the case of ribs, which intersect the stringers passing through so-called “mouseholes”, these local flarings of the stringers are required in order to join the ribs to the panel by means of riveting.

In the prior art, these local flarings of the bases of the stiffening stringers are located in flat zones of the skin, since their location in zones affected by ramps where there is a change in thickness is considered to be problematic owing to the fact that it is incompatible with the requirements of the tools customarily used during manufacture.

One drawback thereof is that this need conditions the design of the skin, resulting in an increase in its weight since the thickness of given zones must be increased more than that which is strictly necessary from a strength point of view.

The aim of the present invention is to overcome this drawback.

### SUMMARY OR THE INVENTION

An object of the present invention is to provide stringers for stiffening a panel of an aircraft structure made of composite material, namely a material consisting of an organic matrix and continuous fibres which are mainly based on epoxy resins and carbon fibres, having local flared zones arranged both in the flat zones of the skin and in the zones affected by change-in-thickness ramps.

Another object of the present invention is to provide a panel of an aircraft structure such as an aircraft wing, the weight optimization is not conditioned by the need for the joints between the stiffening stringers and other parts to be provided in flat zones of the skin.

These and other objects are achieved by providing an aircraft component which comprises at least one panel of composite material, formed by a skin and a plurality of stiffening stringers which are configured with a core and a base, said stiffening stringers comprising first local flarings of its bases intended to provide areas for joining with other parts located in flat zones of the skin, wherein said stiffening stringers also comprise second local flarings of its bases which are intended to provide areas for joining with other parts located in zones of the skin which include change-in-thickness ramps, being configured in the form of two end sections located above flat zones of the skin and a central section located above one of said ramps of the skin, one of said end sections acting as an area for joining with other parts.

In a preferred embodiment, the bases of the stiffening stringers in said second local flarings have a constant width Ae in said central section and a width variable between Ae and A in said end sections. It is thus possible to provide a stringer with a local flaring of the base optimized to perform its function of providing an area for joining with another part, being situated in a zone of the skin with a change-in-thickness ramp.

In other preferred embodiments, the ratio between said widths Ae and A lies within the range of 120% to 150% and the length L1 of said central section of the second local flarings lies within the range of 5 to 500 mm. It is thus possible to provide stringers which have local flarings suited for different needs.

In other preferred embodiments, said panel forms part of the skin of an aircraft wing and the parts joined to said stiffening stringers along said second local flarings are a rib or a support for a device. It is thus possible to facilitate optimization of the design of said skin.

Other characteristic features and advantages of the present invention will become clear from the detailed description which follows of examples of embodiment of the subject thereof with reference to the accompanying figures.

### DESCRIPTION OF THE FIGURES

FIG. 1 is a perspective view of the inside of an aircraft wing showing the location of the local flarings of the base of a stiffening rib in flat zones of the skin according to the prior art.

FIG. 2 is a plan view of the inside of an aircraft wing which shows a local flaring of the base of a stiffening stringer according to the present invention.

### DETAILED DESCRIPTION OF THE INVENTION

For a better understanding of the invention firstly a panel of the wing of an aircraft with a stiffening stringer having local flarings according to the prior art and secondly said panel with a local flaring of a stiffening stringer according to the present invention shall be described.

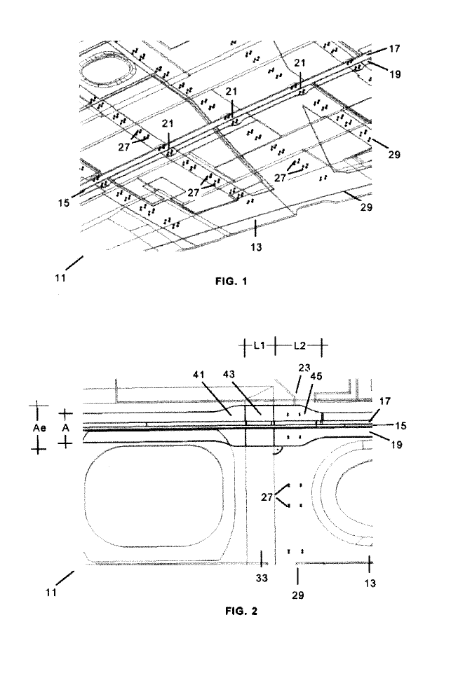

FIG. 1 shows the inside of a panel 11 of an aircraft wing where it is possible to see different thickness zones of its skin 13 with transition ramps between them and a stiffening stringer 15 with a core 17 and a base 19. Typically the stringers 15 are co-bonded to the skin 13 or co-cured together therewith, namely joined by means of a chemical bond performed in an autoclave.

Said FIG. 1 shows in schematic form ribs 29 which are passed through by the rivets 27 which will be used to join them to the panel 11.

The stringer 15 configured with a core 17 and a base 19 has various local flarings 21 in the zones of intersection with the ribs 29 so as to be able to form the corresponding joint by means of the rivets 27. All the local flarings 21 of the stringer 15 are located in flat zones of the skin 13.

With reference to FIG. 2 this shows a local flaring 23 of the base 19 of the stringer 15 according to the present invention for allowing joining thereof to a rib 29 in an area which includes a ramp 33 between zones of the skin 13 of different thickness.

This local flaring 23 comprises, viewed from left to right, a first section 41 with the typical form of the zone having a width increasing from the width A of the base 19 to the broader width Ae in a flat zone of the skin 13 as far as the start of the ramp 33, a second section 43 with a constant width Ae as far as the end of the ramp 33, which leads to another flat zone of the skin 13 having a thickness less than that of the first zone, and a third section 45 with the typical form of the zone having a width decreasing from the flared width Ae to the width A of the base 19 where the intersection with the rib 29 is formed and where the area for joining thereto by means of the rivets 27 is situated.

It is considered that the length L1 of the second section 43 of the local flaring 23 must be within the range of 5 to 500 mm and that the length L2 of the third section 45 provided as area for joining with the rib 29 will be the appropriate length for performing this function.

With regard to the ratio between the width Ae of the second local flarings 23 on the bases 19 of the stringers 15 and the width A of the bases 19 of the stringers, it is considered that it will be within the range of 120% to 150%.

Among the many advantages provided by the present invention it must be mentioned that the base 19 of the stringers 15 may comprise both first local flarings 21 in flat zones of the skin 13 and second local flarings 23 in zones of the skin 13 where there are change-in-thickness ramps 33, which facilitates optimization of the skin weight. Most particularly, it is possible to provide the arrangement shown in FIG. 2, where the axis of the rib 29 is very close to a ramp 33, as well as the location of any other part conditioned by the presence of ramps 33 in the skin 13.

Although the present invention has been described entirely in connection with preferred embodiments, it is evident that it may be subject to those modifications which are within the scope thereof, this not being regarded as limited by the above embodiments, but by the content of the following claims.

1. Aircraft component which comprises at least one panel (11) of composite material, formed by a skin (13) and a plurality of stiffening stringers (15) which are configured with a core (17) and a base (19) of width (A), said stiffening stringers (15) comprising first local flarings (21) of their bases (19) intended to provide areas for joining with other parts located in flat zones of the skin (13), characterized in that said stiffening stringers (15) also comprise second local flarings (23) of their bases (19) which are intended to provide areas for joining with other parts located in zones of the skin (13) which include change-in-thickness ramps (33), being configured in the form of two end sections (41, 45) located above flat zones of the skin (13) and a central section (43) located above one of said ramps (33) of the skin (13), one of said end sections (41, 45) acting as an area for joining with other parts.

2. Aircraft component according to claim 1, characterized in that the bases (19) of the stiffening stringers (15) in said second local flarings (23) have a constant width (Ae) in said central section (43) and a width variable between (Ae) and (A) in said end sections (41, 45).

3. Aircraft component according to claim 2, characterized in that the ratio between said widths (Ae) and (A) lies within the range of 120% to 150%.

4. Aircraft component according to claim 1, characterized in that the length (L1) of said central section (43) of the second local flarings (23) lies within the ranges of 5 to 500 mm.

5. Aircraft component according to claim 1, characterized in that said panel (11) forms part of the skin of a wing.

6. Aircraft component according to claim 5, characterized in that the parts joined to said stiffening stringers (15) in said second local flarings (23) are among the following:
a rib (29);
a support for a device of the aircraft.

7. Aircraft component according to claim 2, characterized in that the length (L1) of said central section (43) of the second local flarings (23) lies within the ranges of 5 to 500 mm.

8. Aircraft component according to claim 3, characterized in that the length (L1) of said central section (43) of the second local flarings (23) lies within the ranges of 5 to 500 mm.

9. Aircraft component according to claim 2, characterized in that said panel (11) forms part of the skin of a wing.

10. Aircraft component according to claim 3, characterized in that said panel (11) forms part of the skin of a wing.

11. Aircraft component according to claim 4, characterized in that said panel (11) forms part of the skin of a wing.
